(19) United States
(12) Patent Application Publication
(10) Pub. No.: US 2006/0241957 A1
(43) Pub. Date: Oct. 26, 2006

(54) Proactive support process using case activity rate

(75) Inventor: Michael Boswell, Leander, TX (US)

Correspondence Address: Baker Botts L.L.P.;One Shell Plaza, 910 Louisiana, Houston, TX, 77002-4995, US

(73) Assignee: Dell Products L.P.

(21) Appl. No.: 11/112,945

(22) Filed: Apr. 22, 2005

(51) Int. Cl. G06Q 99/00

(52) U.S. Cl. 705/1

(57) ABSTRACT

A system and method are presented for analyzing service case data in order to optimize the amount of physical material and human resources needed to maintain operation of complex systems, such as information handling systems. A first set of data related to the one or more customer's experience with one or more models of information handling systems are recorded. In addition, a second set of data related to one or more models of information handling systems (regardless of customer) are also recorded. A CAR index is used to normalize the volume of service call cases that have been addressed based upon the population of systems that could responsible for any particular case. Use of the CAR index allows for a more informative comparison of support cases volume across time, customer, product lines and specific systems than previous figures of merit.

### CROSS REFERENCE TO RELATED APPLICATIONS

The present application is related to the following co-pending U.S. patent applications, namely Ser. No. 10/952,546 entitled “System and Method for Managing Data Concerning Service Dispatches” which was filed on 28 Sep. 2004 by Borkowski et al.; Ser. No. 10/952429 entitled “System and Method for Managing Data Concerning Service Dispatches Involving Geographic Features” which was filed on 28 Sep. 2004 by Schmitt et. al.; Ser. No. 10/952,456 entitled “Apparatus and System for Monitoring and Managing Equipment and Services” which was filed on 28 Sep. 2004 by Schmitt et al.; and [016295.1833] entitled “Method, System and Apparatus for Object-Event Visual Data Modeling and Mining” which was filed on ______ by Payne et al., all of which are incorporated herein by reference.

### BACKGROUND

1 Field of the Invention

The present invention relates to servicing and repairing machines. More specifically, the present invention relates to the servicing of equipment at remote locations and the tracking of problems associated with that equipment.

2 Background of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

As information processing systems have become more pervasive, they have also become more complex because those systems are tasked more extensively. As a result, failure of the information processing systems can have a significant and deleterious affect on the performance of an organization. As a consequence, companies that manufacture the information processing systems are often asked by their customers to service broken machines and/or systems.

The quality of care that customers provide to their machines varies considerably. Moreover, some models of machines also have disparate reliability rates and some require inordinate amounts of service. The above-mentioned disparities places an additional burden on field service technicians and remote support technicians, and increases the costs of providing repair services to customers. The efficient allocation of technicians and spare parts for potential need in disparate locations is a difficult problem. If technician allocation can be made more efficient, cost savings would be apparent. There is, therefore, a need in the art for a system and method for allocating maintenance and repair resources efficiently.

### SUMMARY OF THE INVENTION

The present invention solves the problems inherent in the art by providing a system and method for allocating maintenance and repair resources efficiently. A first set of data related to the one or more customer's experience with one or more models of information handling systems are recorded. In addition, a second set of data related to one or more models of machines (making up the information handling system, regardless of customer) are also recorded. Once the sets of data are recorded, they can be analyzed as further described herein.

One of the problems with maintaining complex systems, such as information handling systems, in the customer's facility is knowing how well the particular customer takes care of their machines. In some instances, the customer takes great care for the devices and other devices, which generally leads to relatively trouble-free performance. In other instances, the machines and/or systems are placed in warm and/or damp environments (among many other factors), which often leads to problems. The first set of data and the second set of data can be best be used to determine the amount of support needed by a set of computer systems in the field. In other words, one of the goals is to predict the amount of technical and material support is needed to keep a given set of machines operation in a given environment.

The case activity rate (“CAR”) is a parameter that can be used to measure the amount of support necessary for a set of complex devices, such as computer servers and/or personal computers. A CAR index is simply a way of normalizing the volume of service call cases that have been addressed based upon the population of systems that could responsible for any particular case (e.g., one or more service calls). The CAR index allows for a more informative comparison of support cases volume across time, customer, product lines and specific systems than previous figures of merit.

The CAR index is the ratio of support cases opened over a fixed period of time to the number of systems under contract for that period of time. The resulting data is then annualized in order to facilitate comparison of data from disparate measurement periods. The annualized data can then be used to optimize the amount of support (both material and human) needed for a given geographic area or even for specific customers or specific models of machines and/or systems.

Another metric disclosed herein is the predicted case activity rate delta (“PCAR-D”), which is an indicator of greater (or lesser) number of service cases for a particular data set (e.g., customers, locations, product lines, etc.). PCAR-D is the difference between the predicted case activity rate (“PCAR”) and the actual case activity rate. Because the overall quality of the product in question is the key driver of the average case activity rage for a specific product, using PCAR-D has the effect of isolating the customer's impact on their overall case activity rate from the product quality component of the case activity rate. In other words, the product quality driver should be equal for all customers, and the customer's impact on PCAR-D is unique to each customer.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is a block diagram illustrating an information handling system according to the teachings of the present invention.

FIG. 2 is a flowchart illustrating a method according to the teachings of the present invention.

FIG. 3 is a Six Sigma Control Chart illustrating the cases a support unit is handling per year versus time according to the teachings of the present invention.

FIG. 4 is an Ishikawa diagram illustrating the causes of high PCAR delta values according to the teachings of the present invention.

The present disclosure may be susceptible to various modifications and alternative forms. Specific exemplary embodiments thereof are shown by way of example in the drawing and are described herein in detail. It should be understood, however, that the description set forth herein of specific embodiments is not intended to limit the present disclosure to the particular forms disclosed. Rather, all modifications, alternatives, and equivalents falling within the spirit and scope of the invention as defined by the appended claims are intended to be covered.

### DETAILED DESCRIPTION

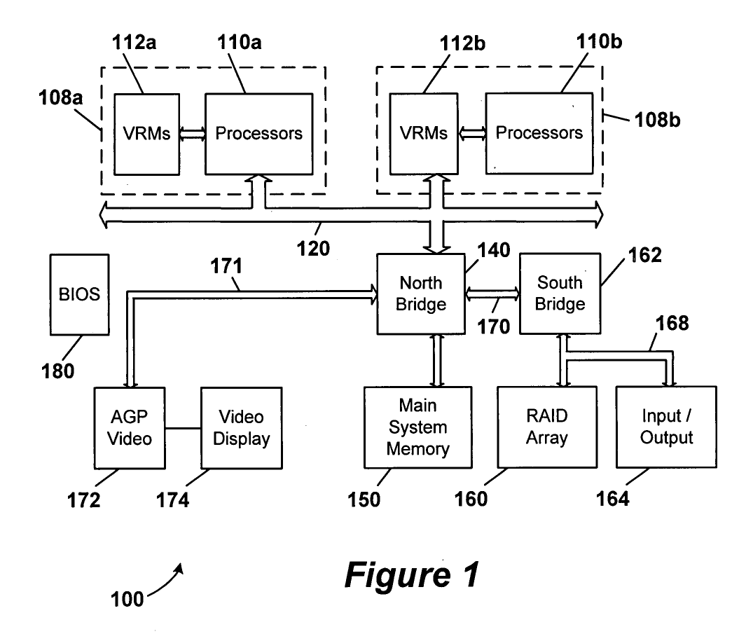

Elements of the present disclosure can be implemented on a computer system, as illustrated in FIG. 1. Referring to FIG. 1, depicted is an information handling system, generally referenced by the numeral 100, having electronic components mounted on at least one printed circuit board (“PCB”) (not shown) and communicating data and control signals there between over signal buses. In one embodiment, the information handling system may be a computer system. The information handling system may be composed processors 110 and associated voltage regulator modules (“VRMs”) 112 configured as processor nodes 108. There may be one or more processor nodes 108, one or more processors 110, and one or more VRMs 112, illustrated in FIG. 1 as nodes 108a and 108b, processors 110a and 110b and VRMs 112a and 112b, respectively. A north bridge 140, which may also be referred to as a “memory controller hub” or a “memory controller,” may be coupled to a main system memory 150. The north bridge 140 may be coupled to the processors 110 via the host bus 120. The north bridge 140 is generally considered an application specific chip set that provides connectivity to various buses, and integrates other system functions such as memory interface. For example, an INTEL® 820E and/or INTEL® 815E chip set, available from the Intel Corporation of Santa Clara, Calif., provides at least a portion of the north bridge 140. The chip set may also be packaged as an application specific integrated circuit (“ASIC”). The north bridge 140 typically includes functionality to couple the main system memory 150 to other devices within the information handling system 100. Thus, memory controller functions, such as main memory control functions, typically reside in the north bridge 140. In addition, the north bridge 140 provides bus control to handle transfers between the host bus 120 and a second bus(es), e.g., PCI bus 170 and AGP bus 171, the AGP bus 171 being coupled to the AGP video 172 and/or the video display 174. The second bus may also comprise other industry standard buses or proprietary buses, e.g., ISA, SCSI, USB buses 168 through a south bridge (bus interface) 162. These secondary buses 168 may have their own interfaces and controllers, e.g., RAID Array storage system 160 and input/output interface(s) 164. Finally, a BIOS 180 may be operative with the information handling system 100 as illustrated in FIG. 1. The information handling system 100 can be combined with other like systems to form larger systems. Moreover, the information handling system 100, can be combined with other elements, such as networking elements and or other information handling systems, to form even larger and more complex information handling systems such as, for example, clusters or other enterprise resource planning system, such as an enterprise resource planning portal.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory as described above. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system described above, or similar systems, may be used to implement the systems and methods described herein. It should be noted that the information handling system needed to implement the methods and systems described herein may be implemented in hardware, in software (in the form of one or more instructions), or in any combination of hardware or software. Moreover, no specific software language is required to implement the systems and methods described herein, and they may be implemented using any desired programming language.

An information and telecommunications center having one or more individuals having access to a command station is provided. The command station typically comprises a computer (such as a personal computer (“PC”)) that is operable with a network. Exemplary networks include, for example, a telecommunications network and a data network, such as the Internet, and the like. The command center may also include with one or more large projection (and/or plasma) screens in a large room, as well as conference facilities, all with access through communications mechanisms such as telephones, facsimile, wireless telegraphy, voice-over IP (“VoIP”), email, etc. to individuals from within multiple organizations, such as an original equipment manufacturer (“OEM”) and one or more third-party vendors that supply parts and/or labor services. One or more of the command stations within the command center may interact and/or manipulate one or more elements of the command center, or one or more resources associated with one or more organizations. Typically, individuals, such as dispatchers or other representatives, will interact with the command center through the command station. However, groups of people may coordinate activities through their respective command stations via the communications capabilities of the command center.

A first set of data related to the one or more customer's experience with one or more models of machines are recorded. In addition, a second set of data related to one or more models of machines (regardless of customer) are also recorded. Once the sets of data are recorded, they can be analyzed as further described herein.

One of the problems with maintaining complex systems, such as information handling systems, in the customer's facility is knowing how well the particular customer takes care of their machines. In some instances, the customer takes great care for the servers and other devices, which generally leads to relatively trouble-free performance. In other instances, the servers are placed in warm and/or damp environments or other causes which often lead to problems. The first and second sets of data can be best be used to determine the amount of support needed by a set of computer systems in the field for a particular customer and/or for a particular line of devices. In other words, one of the goals is to predict the amount of technical and material support is needed to keep a given set of machines operation in a given environment.

The case activity rate (“CAR”) is a parameter that can be used to measure the amount of support necessary for a set of complex devices, such as computer servers and/or personal computers. A CAR index is simply a way of normalizing the volume of service call cases that have been addressed based upon the population of systems that could responsible for any particular case. The CAR index allows for a more informative comparison of support cases volume across time, customer, product lines and specific systems than previous figures of merit.

The CAR index is the ratio of support cases opened over a fixed period of time to the number of systems under contract for that period of time. The resulting data is then annualized in order to facilitate comparison of data from disparate measurement periods. The CAR can be calculated, for example, for one or more customers, an individual system or group of systems, and entire product lines.

By comparing an individual system case activity rate (“SCAR”) to the product line case activity rate (“CAR”for all products) and the customer case activity rate (“CCAR”), one can isolate system that have an unusually high failure rate. In other words, a SCAR value that was much higher than the CAR, but owned and operated by a customer with a low CCAR indicates something is amiss with that particular system. Once identified, the problematic system can be considered for one or more remedial actions, such as capture and failure analysis, customer education, and pro-active field repairs. Other remedial procedures may be implemented as deemed necessary to maximize the particular figure of merit, such as customer satisfaction, uptime of the system, and the like.

A CCAR can be calculated by using the CAR values along with the customer's installed product mix. In one embodiment, the actual case activity rate (“CAR”) is compared to a predicted case activity rate (“PCAR”) in order to isolate the customer's environmental impact within the CAR. Such isolation allows the allocation of pro-active resources to work with the customers that have the highest negative environmental impact for their case activity rate. While it can be important to isolate customer issues from system issue in the allocation of support resources, other figures of merit can be used as well. For example, the resulting data can be used to “rate”customers and handle them differently based on that rating. In other words, customers that have an unusually high number of support calls for systems that have an otherwise low failure rate can be given more remedial support staff. Alternatively, customers with a different rating, i.e., ones that have few service calls on systems with an otherwise high failure rate, can be assigned to different personnel who only handle the truly difficult problems.

The case activity rate index (“CAR index”) can be calculated at many ways. For example, the CAR index can be based on service contract level (e.g., gold, silver or bronze), by customer, by product line, and/or by specific system. For convenience, the CAR index is annualized. However, the index can be normalized to any time period. Table 1 illustrates examples of calculating CAR index.

| CAR Index Type | Algorithm |
|---|---|
| by Contract Type | $\frac{New support cases for 6 months}{Systems under Gold Contract} \times 2$ |
| by Customer | $\frac{New support cases by customer for 6 months}{Customer Systems under Gold Contract} \times 2$ |
| by Product Line | $\frac{New System “ X ” cases for 1 month}{All Systems “ X ” under contract} \times 12$ |
| by Specific System | $\frac{Total number of incidents}{Number of weeks under contract} \times 52$ |

The predicted case activity rate (“PCAR”) can be calculated as:

$$\frac{\sum ( ( SystemTypeQuantity * SystemCAR ) , SystemType )}{\sum Systems} = PCAR$$

PCAR is used to predict the customers case activity rate while taking into account the specific product mix used by that particular customer. In other words, a customer with 90% of their product mix in HIGH CAR products would be expected (predicted) to have more cases per year than a customer with 90% of their produce mix in LOW CAR products. PCAR takes the product mix into account in a meaningful manner.

PCAR delta (“PCAR-D”) is the difference between the PCAR and the customer's case activity rate (CAR), which can be expressed as:
CAR−PCAR=PCAR-D

A positive PCAR-D value indicates that there are a greater than normal number of support cases from this data set. The abnormally high number of support cases (CAR values) can be based on customer case activity rate, location case activity rate or other metric. Because the overall product quality is the key driver of the “average”CAR for a specific product, using PCAR-D has the effect of isolating the customer's impact to their overall CAR from the product quality component of the CAR. In other words, the product quality driver should be equal across all customers. Whereas the customers impact is unique to each customer.

It is helpful to understand how to represent accurately the CAR value over long sample periods. The longer the sampling period, the more accurate the prediction of case volume. A problem occurs when the number of systems that a customer owns changes over the sample period. A dramatic example would be when the sample period is 6 months and the customer starts the sample period with 10 systems and ends with 100 systems. In the simple form of the calculations used above, one would have only a single number for the number of systems. We resolve this problem by taking weekly data points of the install base and then averaging the weekly install base numbers over the sample period. The two examples below illustrate the calculation of the weekly average that is used in the calculations.

### Example 1

Week

| | W1 | W2 | W3 | W4 | |
|---|---|---|---|---|---|
| Systems | 10 | 10 | 10 | 100 | Average = 32.5 |

### Example 2

Week

| | W1 | W2 | W3 | W4 | |
|---|---|---|---|---|---|
| Systems | 10 | 100 | 100 | 100 | Average = 77.5 |

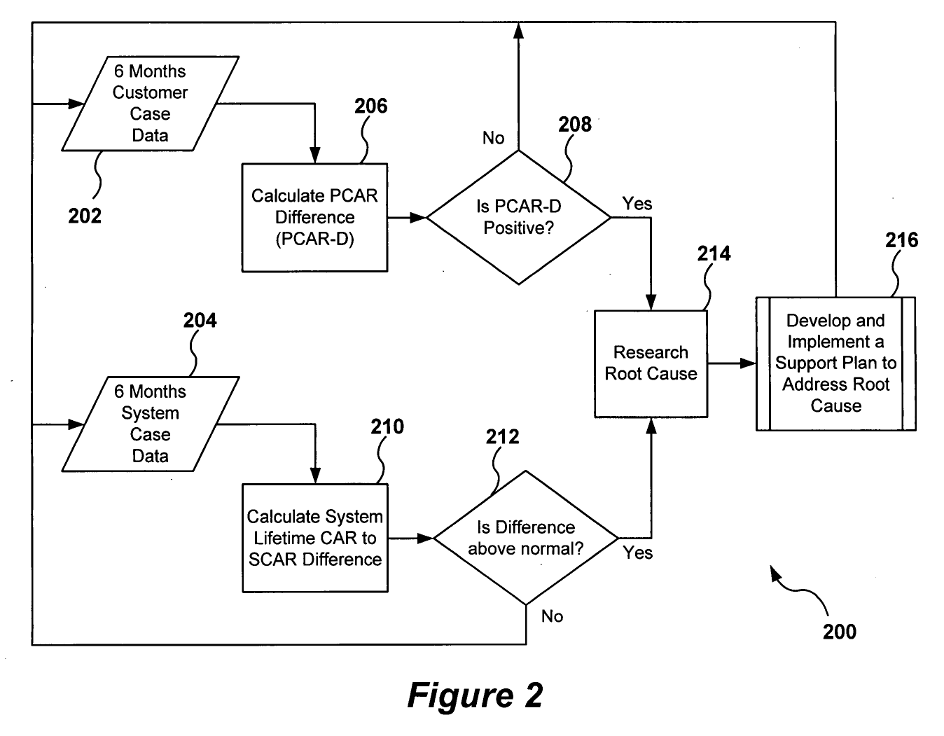

An embodiment of the method is illustrated in FIG. 2. Referring to FIG. 2, the method 200 begins by gathering customer case data 202 and system case data 204 for a given period of time, such as 6 months (although any other time period could be used). Customer case data 202 can be, for example, the number of times the support call center receives a call from that particular customer, or can be something more circumspect, such as a call for a particular problem by the customer. System case data 204 can be, for example, all of the requests for support for any particular system, such as an information handling system. It should be noted that any two or more CAR Index Types may be used in any combination with the method 200, and that the selection of the two for the flowchart in FIG. 2 is merely illustrative.

Once the data 202 and 204 have been gathered, a first set of CAR deltas (differences) is calculated. In the instance of the customer case data 202, the customer (actual) CAR data is compared to the predicted case activity rate (PCAR) to determine the difference between the customer's experience with the predicted value over the same time period (the “PCAR-D”206). If the PCAR-D was positive 208, meaning that the customer had more problems than overall customer experience with all product lines, then research 214 can be conducted to determine the root cause of the problem to explain why that particular customer is experiencing more problems than expected. When the research 214 is concluded, a support plan 216 can be developed and/or implemented to address the root cause of the customer's problem. The support plan 216 can include a variety of remedies, such as additional support staff, differently trained support staff, differently trained customer support staff, more or different pre-positioning of spare parts (in case of device failure), re-evaluation of the current system's suitability for the customer's task, and the like. If the PCAR-D 206 is negative, or once the support plan 216 (if any) is developed or implemented, more customer case data can be gathered and the cycle repeated.

In the instance of system case data 204, the data is analyzed to determine the difference 210 between that particular system CAR (SCAR) and the lifetime CAR for all like systems. Generally statistical information regarding the support call data for any given system is tracked, so that different metrics are known for the given system, such as mean-time-between-failure, average performance, median performance, and the like. Once the difference 210 is known, a determination 212 can be whether or not that difference exceeds a given threshold. In other words, the determination 212 is positive if the problems with a given system is deemed to be abnormally high vis-à-vis other systems. If so, research 214 is conducted to determine the root cause of the abnormality. If the root cause can be determined, a support plan 216 can be developed and/or implemented to address the root cause of the perceived problems. If the determination 212 is that there is no particular problem, or after the support plan 216 has been developed and/or implemented, additional data 202 and 204 for the next time period can be collected. Alternatively, the method 200 can be implemented using other types of data, such as contract type or product line type information over the same time period. In another embodiment, the same or different information is compared to results from other time periods to determine if the support plans 216 are having the intended effect.

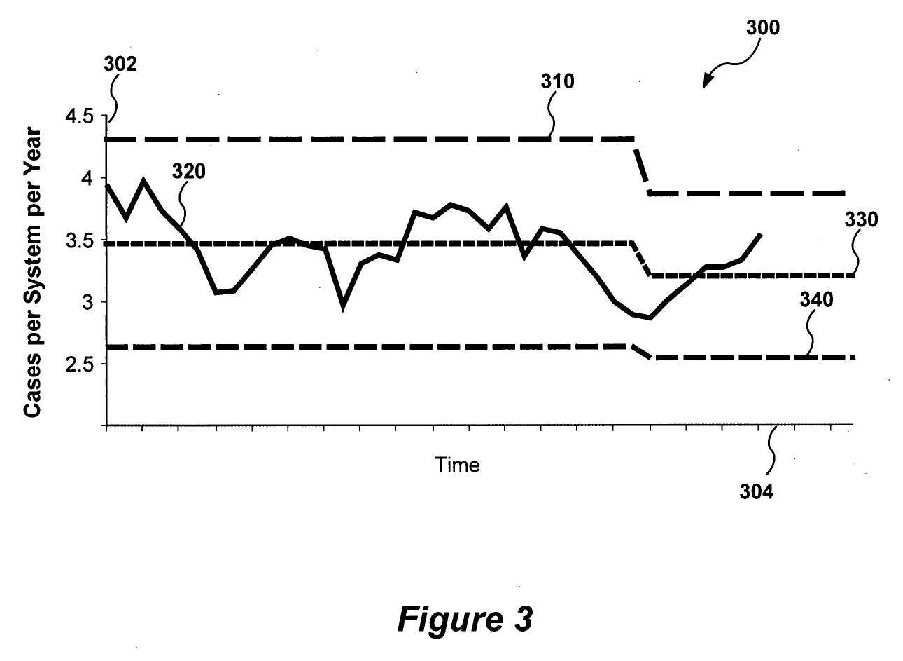

FIG. 3 is a Six Sigma Control Chart 300 of, for example, the cases for a given system per year 302 over a period of time 304. The CAR 320 can be compared to the mean number 220 of support call cases per system er year oer the time 304. Generally, the CAR 320 will fall between the upper control limit (“UCL”) 310 and the lower control limit (“LCL”) 340. Differences between the CAR 320 and the mean 330 for any point in time 304 can indicate problems with certain systems on an overall basis. However, the same plot 300 can be created to analyze any combination of statistical information regarding the parameter and indexes described herein. For example, when analyzing PCAR data over time, one can evaluate trends in product quality. Because the CAR takes into account all cases, CAR is influenced by indirect quality issues, such as usability issues and even suitability for a given task, in addition to pure component reliability.

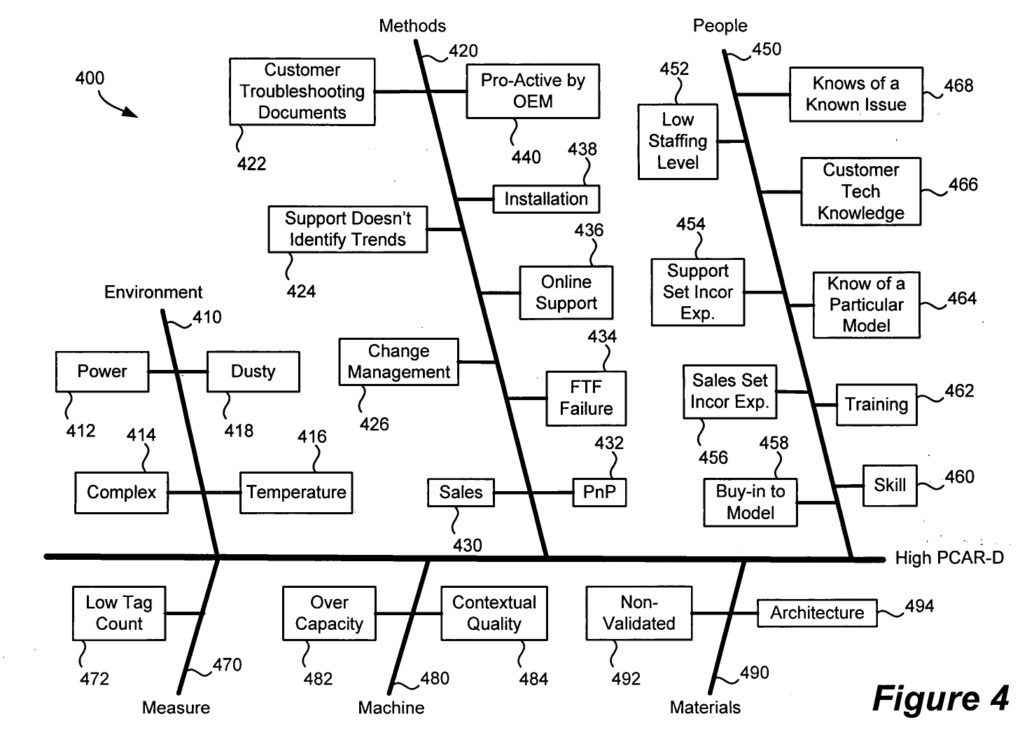

A more complete list of the potential root causes of a high PCAR-D value is illustrated in FIG. 4. FIG. 4 is an Ishikawa diagram illustrating the potential causes and effects of machine/system problems. In this embodiment, the causes result in a high PCAR-D value, and are used in the research root cause 214 of FIG. 2. The root causes so determined can be used to develop and implement 216 a support plan to address the root causes 214 that are in play with the particular customer. Other root causes related to environment could be incorporated into the PCAR-D calculation.

Referring to FIG. 4, the Ishikawa diagram has six cause branches, environment 410, methods 420, people 450, measure 470, machine 480 and materials 490. The environment branch 410 has four root causes, namely power 412 (typically lack of “clean” power, or insufficient voltage or current), complexity 414 (typically references the system/solution configuration; in some cases the solution configurations are very complex, with many systems interacting, which can lead to increased PCAR-D), temperature 416 (typically that the work environment is too hot, although it could be too cold), and dusty 418 (meaning that the environment creates too much dust which is ingested by the machines or systems in question).

The methods branch 420 of FIG. 4 contains nine root causes, namely customer troubleshooting documents 422 (which may be inaccurate), the support personnel or diagnostic mechanisms do not identify trends 424 that indicate a problem is present, change management 426 (typically customer management that does not manage the change of machines, systems or procedures optimally), sales 430 (indicating that the customer was sold the wrong machine or system, Process and Procedure (“PnP”) 432, First Time Fix (“FTF”) failure 434, online support problems 436 (typically related to getting the wrong support information from online resources), Installation problems 438, and/or pro-active remediation by the original equipment manufacturer 440 (“OEM”). Other root causes related to methods could be incorporated into the PCAR-D calculation.

The people branch 450 has nine potential root causes, namely low staffing level 452 (either by the customer or the organization responsible for support), support setting incorrect expectations 454 (meaning the customer was led to believe something that they shouldn't have been told, sales setting incorrect expectations 456 (meaning the OEM's sales representatives gave the customer the wrong impression), buy-in model 458 (the “buy-in” is the customer's acceptance of, for example, an OEM's support model, even if a customer understands the OEM's support model, problems that raise the PCAD-D may be incurred if the customer disregards the OEM support model and works with the OEM as if they had a different support model), the skill level 460 of the customer or support staff, the training level 462 of the customer and or OEM's support staff, the knowledge of the intricacies of a particular model 464 in service by the customer, the knowledge of level the customer technician 466, and whether or not one or more known issues 468 with the machine or system are known by the customer and/or the OEM. Other root causes related to people could be incorporated into the PCAR-D calculation.

The measure branch 470 contains one potential root cause, namely a low tag count (typically meaning that the customer has so few units that a statistically representative sample is not possible). Other root causes related to measurements could be incorporated into the PCAR-D calculation.

The machine branch 480 has two potential root causes, namely over capacity 482 (meaning that the machines in question have too much to do), and contextual quality (meaning the types of problems presented to the machines is not a good fit for those particular machines). Other root causes related to machine issues could be incorporated into the PCAR-D calculation.

The materials branch 490 has two potential root causes, namely non-validated 492 (meaning that the devices or systems in question have not been specifically tested in order to predict their future reliability), and architecture 494 (meaning that the architecture of the system or the individual machines was unsuited to the problem posed by the customer). Other root causes related to materials could be incorporated into the PCAR-D calculation.

The methods and systems described herein may be implemented on an information handling systems, such as the one depicted in FIG. 1. The instructions necessary to implement the methods and systems descried herein and illustrated in FIG. 2 (and their variants) may be implemented as instructions in software, in hardware, or in any combination of hardware and software. The instructions can be placed in, for example, main system memory 150 (see FIG. 1), on persistent memory, such as a hard disk, or on any computer-readable medium, such as a hard disk, CD, DVD, floppy disk, memory stick, and the like in the form of data structures that can be loaded into, for example, one or more processors 110 for execution.

The invention, therefore, is well adapted to carry out the objects and to attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alteration, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An information handling system capable of executing one or more instructions, the instructions comprising:
gathering actual data about an index type;
providing predicted data about the index type;
comparing the actual data with the predicted data;
if the difference between the actual data and the predicted data exceeds a threshold, then determining the root cause of the difference and develop a support plan to address the root cause.

2. The system of claim 1, wherein the index type is customer case type.

3. The system of claim 1, wherein the actual data is customer case data.

4. The system of claim 1, wherein the predicted data is PCAR data.

5. The system of claim 1, wherein the index type is a system case type.

6. The system of claim 1, wherein the actual data is system case data.

7. The system of claim 1, wherein the predicted data is lifetime CAR data.

8. The system of claim 1, wherein the index type is a product case type.

9. The system of claim 1, wherein the index type is contract case data.

10. A method of optimizing support resources comprising:
gathering actual data about an index type;
providing predicted data about the index type;
comparing the actual data with the predicted data;
if the difference between the actual data and the predicted data exceeds a threshold, then determining the root cause of the difference and develop a support plan to address the root cause.

11. The method of claim 10, wherein the index type is customer case type.

12. The method of claim 10, wherein the actual data is customer case data.

13. The method of claim 10, wherein the predicted data is PCAR data.

14. The method of claim 10, wherein the index type is a system case type.

15. The method of claim 10, wherein the actual data is system case data.

16. The method of claim 10, wherein the predicted data is lifetime CAR data.

17. The method of claim 10, wherein the index type is a product case type.

18. The method of claim 10, wherein the index type is contract case data.

19. A computer-readable medium containing a data structure comprising:
information for gathering actual data about an index type;
information for providing predicted data about the index type;
information for comparing the actual data with the predicted data;
information for determining if the difference between the actual data and the predicted data exceeds a threshold, then determining the root cause of the difference and develop a support plan to address the root cause.
